(19) United States
(12) Patent Application Publication
(10) Pub. No.: US 2015/0227339 A1
(43) Pub. Date: Aug. 13, 2015

(54) Multi-media Extension Method and Related Multi-Media System

(71) Applicant: Wistron Corporation, New Taipei City (TW)

(72) Inventors: Ping-Hung Chen, New Taipei City (TW); Fang-Wen Liao, New Taipei City (TW)

(73) Assignee: Wistron Corporation, New Taipei City (TW)

(21) Appl. No.: 14/284,410

(22) Filed: May 22, 2014

(30) Foreign Application Priority Data
Feb. 11, 2014 (TW) 103104477

(51) Int. Cl. G06F 3/16; G10L 19/008

(52) U.S. Cl. CPC G06F 3/162; G10L 19/008

(57) ABSTRACT

The present disclosure provides a multi-media extension method. The multi-media extension method includes capturing a multi-media file in a first format from a mobile device when a first wireless link is established between the mobile device and a computer system, converting the multi-media file with the first format to a multi-media file with a second format, compressing the multi-media with the second format into a plurality of data packets, and sending and receiving the data packets via the first wireless link, de-compressing the packets to the multi-media file with the second format, converting the multi-media file with the second format back to the multi-media file with the first format and playing the multi-media file with the first format on the computer system.

### BACKGROUND OF THE INVENTION

1. Field of the Invention

The present invention relates to a multi-media extension method and related multi-media system, and more particularly, a multi-media extension method and related multi-media system via wireless communication.

2. Description of the Prior Art

Since the smart phone prevails nowadays, it seems like almost everybody has one. The smart phone already became a personal gadget, replacing the traditional music player (e.g. MP3 player). Besides, the number of home computer has decreased. There is barely one All-In-One (AIO) computer in each family. Mostly, the AIO computers are equipped with a fascinating audio device and a high quality speaker.

The hybrid products on the market use the smart phone as a core and the AIO computer as a storage device. The audio files stored in the AIO computer can be accessed through the smart phone and played on the smart phone via wireless. In this way, however, the other members in the family are not able to join in and the joy is exclusive. Besides, the smart phone is always not equipped with a high fidelity speaker.

### SUMMARY OF THE INVENTION

It's therefore an objective of the present invention to provide a multi-media extension method to extend a multi-media file stored in the mobile device to a computer system.

An embodiment of the invention discloses an extension method of multi-media playing. The extension method comprises capturing a multi-media file with a first format from a mobile device when a first wireless link is established between the mobile device and a computer system; converting the multi-media file with the first format into multi-media file with a second format, wherein the multi-media file with the second format has a smaller size than the multi-media file with the first format; compressing the multi-media file into a plurality of data packets; sending and receiving the plurality of data packets via the first wireless link; de-compressing the plurality of data packets back into the multi-media with the second format; converting the multi-media with the second format into the multi-media with the first format; and playing the multi-media with the first format on the computer system.

An embodiment of the invention further discloses a multi-media extension system. The multi-media extension system comprises a mobile device a mobile device and a computer system. The mobile device comprises a capturing unit, a first format conversion unit, a compression unit and a first wireless unit. The capturing unit is used for capturing a multi-media file with a first format from the mobile device when a first wireless link is established. The first format conversion unit is used for converting the multi-media file with the first format into a multi-media file with a second format. The multi-media with the second format has a smaller size than the multi-media with the first format. The compression unit is used for compressing the multi-media file with the second format into a plurality of data packets. The first wireless unit is used for sending the plurality of packet via the first wireless link. The computer system comprises a second wireless unit, a second format conversion unit, a de-compression unit, and a plurality of playing devices. The second wireless unit is used for receiving the plurality of data packets via the first wireless link. The de-compression unit is used for de-compressing the plurality of data packets back into the multi-media file with the second format. The second format conversion unit is used for converting the multi-media file with the second format into the multi-media file with the first format. The plurality of playing devices is used for playing the multi-media file with the first format. The first wireless link is established between the mobile device and the computer system.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of an exemplary multi-media system.

FIG. 2 is a flow chart of an exemplary process.

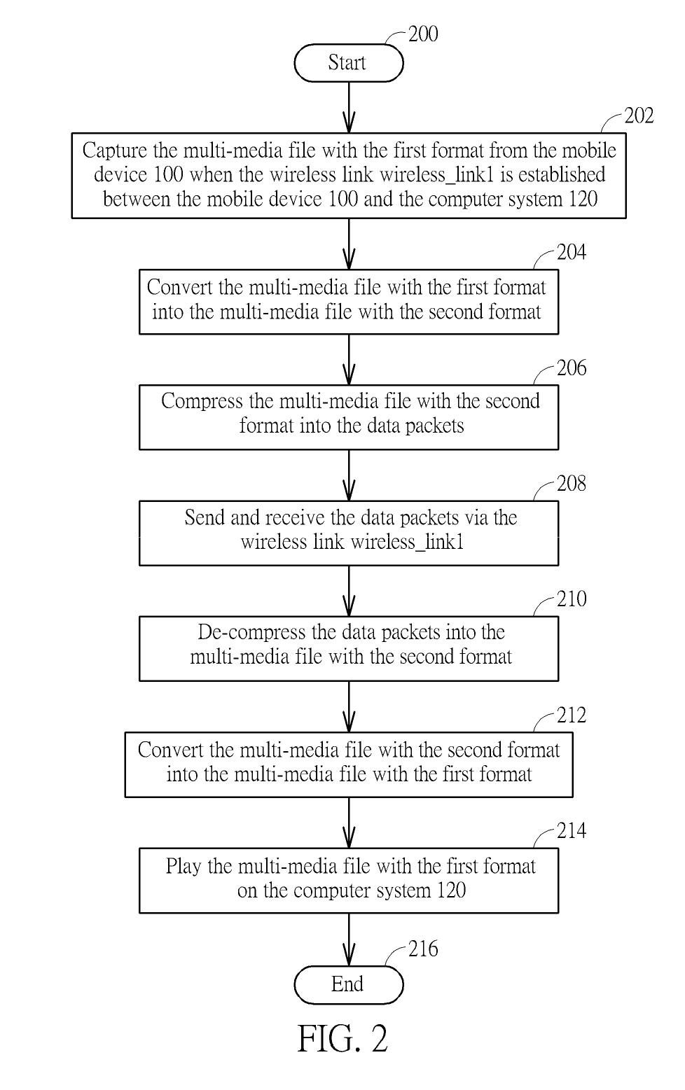

### DETAILED DESCRIPTION

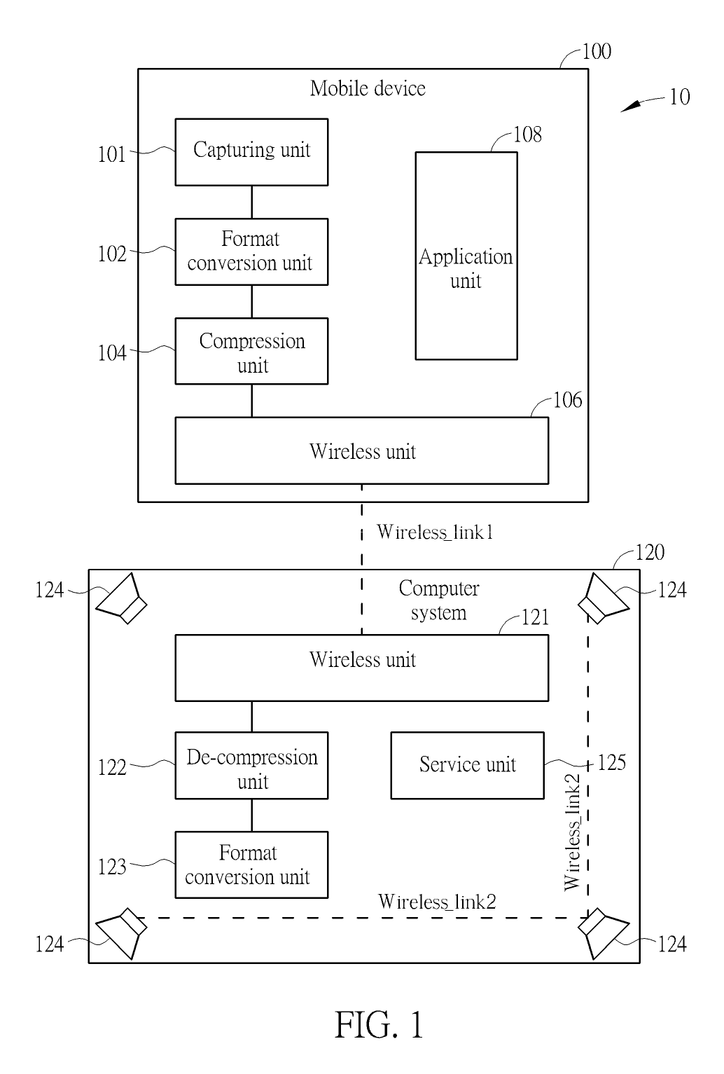

Please refer to FIG. 1, which is a schematic diagram of a multi-media system 10. The multi-media system 10 includes a mobile device 100 and a computer system 120. Preferably, the mobile device 100 could be a smart phone, a tablet or a laptop, but not limited herein. The computer system 120 could be an All-In-One (AIO) computer. The mobile device 100 includes a capturing unit 101, a format conversion unit 102, a compression unit 104, a wireless unit 106 and an application unit 108. The capturing unit 101 is used for capturing a multi-media file with a first format when a wireless link wireless link1 is established. The format conversion unit 102 is coupled to the capturing unit 101 and used for converting the multi-media file with the first format into a multi-media file with a second format which has a smaller size than the multi-media with the first format. The compression unit 104 is used for compressing the multi-media file with the second format into data packets. The wireless unit 106 is used for sending the data packets via the wireless link wireless link1. The application unit 108 could be a multi-media playing program installed on the mobile device 100 or a remoter. A user of the mobile device 100 can use the application unit 108 to play the multi-media file stored in the mobile device 100. The computer system 120 includes a wireless unit 121, a de-compression unit 122, a format conversion unit 123, multiple playing devices 124 and a service unit 125. The wireless unit 121 is used for receiving the data packets via the wireless link wireless_link1. The de-compression unit 122 is used for de-compressing the data packets back into the multi-media file with the second format. The format conversion unit 123 is used for converting the multi-media file with the second format into the multi-media file with the first format. The playing devices 124 are used for playing the multi-media file with the first format. A wireless link wireless_link2 can be established among the playing devices 124. Preferably, the wireless link wireless_link2 is a couple link. In some examples, the playing devices 124 could be multiple speakers of the computer system 120. The service unit 125 is an Terminate and Stay Resident (TSR) program on the computer system 120 and used for controlling and managing the aforementioned wireless unit 121, de-compression unit 122, format conversion 123 and playing devices 124.

Briefly, the mobile device 122 sends the multi-media file to the computer system 120 via the wireless link wireless link1 and the multi-media file is played by the playing devices 124 of the computer system 120 without duplicating the multi-media file on the computer system 120. Meanwhile, the synchronization between the mobile device 100 and the computer system 120 are achieved. In addition, a user can play the multi-media file via the application unit 108 (e.g. multi-media playing program or remoter) of the mobile device 100 instead of operating in front of the computer system 120.

Further, the application unit 108 of the mobile device 100 could display a message to the user, inquiring whether the user wants to establish the wireless link wireless link1 between the mobile device 100 and the computer system 120. The message is used for triggering the establishment of the first wireless link. If the wireless link wireless link1 between the mobile device 100 and the computer system 120 is not established, the mobile device 100 plays the multi-media file from its playing device (not shown in FIG. 1).

In some examples, the multi-media file with the first format could be an audio file with a WAV format while the multi-media with the second format could be an audio file with an AC3 format. Moreover, the data packets are complied with User Datagram Protocol (UDP) and the wireless link wireless link1 is complied with Wi-Fi direct protocol. For example, the couple link among speakers (i.e. playing devices 123) of an AIO computer (i.e. computer system 120) is established in a Wi-Fi environment by using Wi-Fi. When a user of a mobile phone (i.e. the mobile device 100) executes a multi-media playing program (i.e. the application unit 108) on the mobile phone to play a WAV audio file, the multi-media playing program displays a message to inquire whether the user would like to establish the peer-to-peer wireless link wireless link1 via Wi-Fi direct. If the wireless link wireless link1 is established, the multi-media playing program will communicate with a Terminate and Stay Resident (TSR) program (i.e. the service unit 125). When the user intends to play the WAV audio file on the AIO computer, the capturing unit 101 of the mobile phone captures the WAV audio file. Then, the format conversion unit 102 converts the WAV audio file into an AC3 audio file and further divides the AC3 audio file into multiple channels. The compression unit 140 compresses the AC3 audio files into UDP data packets and the wireless unit 106 sends the UDP data packets to the wireless unit 121 of the AIO computer via Wi-Fi direct. When the wireless unit 121 of the AIO computer receives the UDP data packets, the de-compression unit 104 de-compresses the UDP data packets to retrieve the AC3 audio file. The format conversion 123 performs a De-AAC format conversion procedure to convert the AC3 audio file back into the WAV audio file. The WAV audio file is played by multiple speakers on the AIO computer according to the different channels. In this situation, the AIO computer can play music files stored in the mobile phone via Wi-Fi direct, without duplicating the music files to the AIO computer itself. Further, the mobile phone plays the audio files through its own speaker when the wireless link wireless link1 is not established. That is, whether the audio file is stored in the mobile phone or the AIO computer, the AIO computer can play the audio file via Wi-Fi. Thus, the mobile phone and the AIO computer can achieve audio/video synchronization. The duplication is not required and the user does have to get to the front of the AIO computer to play the audio file.

Regarding the operation of the multi-media system 10, it can be synthesized into a process 20. The process 20 is used for extension of the multi-media playing on the mobile device 100. The process 20 includes the following steps:

Step 200: Start.

Step 202: Capture the multi-media file with the first format from the mobile device 100 when the wireless link wireless link1 is established between the mobile device 100 and the computer system 120.

Step 204: Convert the multi-media file with the first format into the multi-media file with the second format.

Step 206: Compress the multi-media file with the second format into the data packets.

Step 208: Send and receive the data packets via the wireless link wireless link1.

Step 210: De-compress the data packets into the multi-media file with the second format.

Step 212: Convert the multi-media file with the second format into the multi-media file with the first format.

Step 214: Play the multi-media file with the first format on the computer system 120.

Step 216: End.

The detailed description of the process 20 can be found above, and thus omitted herein.

To sum up, the audio file stored in the mobile phone can be sent to the AIO computer and paled by the AIO computer without duplication of the audio file or operation in front of the AIO computer. In this situation, the audio file in the mobile phone is extended to the AIO computer.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A multi-media extension method, comprising:
capturing a multi-media file with a first format from a mobile device when a first wireless link is established between the mobile device and a computer system;
converting the multi-media file with the first format into a multi-media file with a second format, wherein the multi-media file with the second format has a smaller size than the multi-media file with the first format;
compressing the multi-media file with the second format into a plurality of data packets;
sending and receiving the plurality of data packets via the first wireless link;
de-compressing the plurality of data packets back into the multi-media with the second format;
converting the multi-media with the second format into the multi-media with the first format; and
playing the multi-media with the first format on the computer system.

2. The multi-media extension method of claim 1, wherein the multi-media with the first format is an audio file with a WAV format and the multi-media file with the second format is an audio file with an AC3 format.

3. The multi-media extension method of claim 1, wherein the plurality of data packets complies with a user datagram protocol.

4. The multi-media extension method of claim 1, wherein the first wireless link complies with a Wi-Fi direct protocol.

5. The multi-media extension method of claim 1 further comprising:
establishing a second wireless link among a plurality of playing devices; and
checking the second wireless link and the first wireless link between the computer system and the mobile device.

6. The multi-media extension method of claim 5, wherein the second wireless link is a couple link.

7. The multi-media extension method of claim 1 further comprising displaying a message, wherein the message is used for triggering the establishment of the first wireless link.

8. The multi-media extension method of claim 1 further comprising playing the multi-media file with the first format on the mobile device when the first wireless link is not established.

9. The multi-media extension method of claim 1, wherein the computer system is an All-In-One computer.

10. A multi-media system, comprising:
a mobile device, comprising:
a capturing unit for capturing a multi-media file with a first format from the mobile device when a first wireless link is established;
a first format conversion unit for converting the multi-media file with the first format into a multi-media file with a second format, wherein the multi-media with the second format has a smaller size than the multi-media with the first format;
a compression unit for compressing the multi-media file with the second format into a plurality of data packets; and
a first wireless unit for sending the plurality of packet via the first wireless link; and
a computer system, comprising:
a second wireless unit for receiving the plurality of data packets via the first wireless link;
a de-compression unit for de-compressing the plurality of data packets back into the multi-media file with the second format;
a second format conversion unit for converting the multi-media file with the second format into the multi-media file with the first format; and
a plurality of playing devices for playing the multi-media file with the first format;
wherein the first wireless link is established between the mobile device and the computer system.

11. The multi-media system of claim 10, wherein the multi-media with the first format is an audio file with a WAV format and the multi-media file with the second format is an audio file with an AC3 format.

12. The multi-media system of claim 10, wherein the plurality of data packets complies with a user datagram protocol.

13. The multi-media system of claim 10, wherein the first wireless link complies with a Wi-Fi direct protocol.

14. The multi-media system of claim 10, wherein the plurality of playing devices are further used for establishing a second wireless link.

15. The multi-media system of claim 14, wherein the second wireless link is a couple link.

16. The multi-media system of claim 10, wherein the mobile device further comprises an application unit for displaying a message, wherein the message is used for triggering the establishment of the first wireless link.

17. The multi-media system of claim 10, wherein the mobile device further comprises a playing device for playing the multi-media file with the first format when the first wireless link is not established.

18. The multi-media system of claim 10, wherein the computer system is an All-In-One computer.
